(19) United States
(12) Patent Application Publication
(10) Pub. No.: US 2013/0198660 A1
(43) Pub. Date: Aug. 1, 2013

(54) Movable search GUI element for restricting search scope

(71) Applicants: Thomas S. Brugler, Fuquay-Varina, NC (US); Vincent C. Conzola, Raleigh, NC (US); Randall A. Craig, Raleigh, NC (US); Todd M. Eischeid, Cary, NC (US); Mark E. Molander, Cary, NC (US)

(72) Inventors: Thomas S. Brugler, Fuquay-Varina, NC (US); Vincent C. Conzola, Raleigh, NC (US); Randall A. Craig, Raleigh, NC (US); Todd M. Eischeid, Cary, NC (US); Mark E. Molander, Cary, NC (US)

(21) Appl. No.: 13/460,850

(22) Filed: May 1, 2012

Related U.S. Application Data
(63) Continuation of application No. 13/360,703, filed on Jan. 28, 2012.

(51) Int. Cl. G06F 3/048; G06F 17/30

(52) U.S. Cl. 715/762; 715/781; 715/769

(57) ABSTRACT

User input is received to cause a search graphical user interface (GUI) element to move within a GUI having areas that each correspond to a content type. The given area over which the search GUI element has been moved is determined. The search GUI element is adapted so that a search performable via the search GUI element is restricted in scope to the content type of the given area. The GUI may be a web page of a web site. The search GUI element may be a search box. The area and/or the search GUI element may be graphically modified to provide visual feedback as to the content type of the given area to which the search is restricted in scope.

### BACKGROUND

Users browse web sites for a multitude of different reasons, including to retrieve content available at the web sites. A web site may have a large amount of content that a user can view. To assist a user in locating the content in which he or she is interested, many web sites provide a search tool, such as a search box. By inputting search terms specifying the content of interest, users can receive from a web site just this content in return.

### SUMMARY

A method of an embodiment of the disclosure includes receiving, by a computing device, user input to cause a search graphical user interface (GUI) element to move within a GUI having areas that each correspond to a content type. The method includes determining, by the computing device, a given area over which the search GUI element has been moved. The method includes adapting, by the computing device, the search GUI element so that a search performable via the search GUI element is restricted in scope to the content type of the given area.

A method of another embodiment of the disclosure includes receiving, by a computing device, user input to cause a search GUI element to move within a web page having areas. Each area corresponds to a content type of content available at a web site encompassing the web page. The method includes determining, by the computing device, a given area over which the search GUI element has been moved. The method includes adapting, by the computing device, the search GUI element so that a search of the content available at the web site performable by the user via the search GUI element is restricted in scope to the content type of the given area.

### BRIEF DESCRIPTION OF THE SEVERAL VIEWS OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIGS. 1 and 2 are diagrams depicting representative search scope restriction by moving a search box, according to an example of the disclosure.

FIG. 3 is a flowchart of a method for restricting search scope by moving a search graphical user interface (GUI) element like a search box, according to an embodiment of the disclosure.

FIGS. 4 and 5 are diagrams of communication flows between a server computing device and a client computing device, according to different implementation embodiments of the disclosure.

FIG. 6 is a diagram of a computing system including the server computing device and the client computing device of FIGS. 4 and 5 in more detail, according to an embodiment of the disclosure.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, a user can locate content of interest on a web site by entering in appropriate search terms within a search box provided on a web page of the web site. However, many web sites have a lot of different types of content. For example, a shopping-oriented web site may permit a user to search products for sale of different types, ranging from electronics, to household items, to even automotive vehicles. Often a user is interested in locating content items that are of one particular type of content.

To permit users to restrict the scope of their searches to a particular content type, some web sites have a dropdown box in which a user can select the content type of interest. In the example above, a user may be able to select via such a dropdown box electronics, household items, and so on. The user's entered search is then performed just in relation to the content of the selected content type. Other web sites have multiple search boxes, where each search box is particular to a specific content type.

Embodiments of the disclosure provide for innovative techniques by which users can restrict the scope of their searches. A web page has a number of areas corresponding to different content types. For example, there may be text in different areas of a shopping-oriented web site that specify electronics, household items, and so on.

A user can in particular move a search graphical user interface (GUI) element, such as a search box, within a web page. The user moves the search box over the area having the content type of interest. If a user is interested in searching electronics, for example, the user moves the search box over the appropriate text on the web site.

The selected area may be graphically highlighted to indicate that searches will then be performed such that they are restricted to the corresponding content type. The search GUI element itself may additionally or alternatively be graphically highlighted to indicate this as well. Rather than having multiple search boxes clutter up a web page, or having an additional GUI element like a dropdown box be displayed, embodiments of the disclosure permit search scope to be restricted even though there is just a single search box, without necessarily having any additional GUI elements.

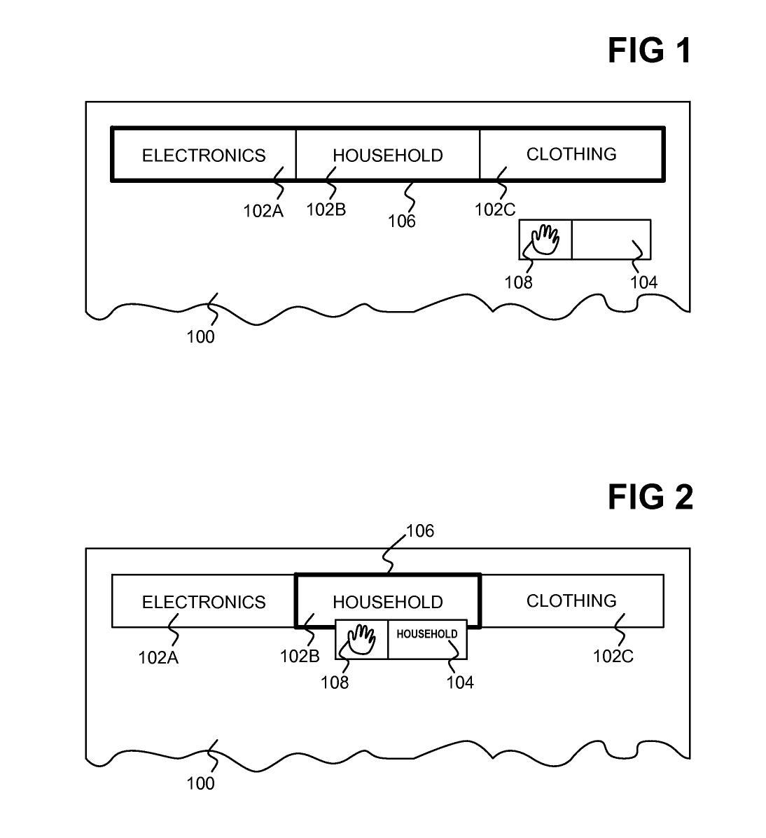

FIGS. 1 and 2 show a representative web page 100 of a web site, in relation to which an example of the disclosure is described. The web page 100 includes multiple graphical areas 102A, 102B, and 102C, which are collectively referred to as the areas 102. Although three areas 102 are displayed, there can be more or less than three areas 102. Each area 102 corresponds to a different type of content available on the web site. In the example of FIGS. 1 and 2, the web site is a shopping-oriented web site. The areas 102A, 102B, and 102C correspond to electronic items, household items, and clothing items, respectively, that users can purchase on the web site.

The web page 100 includes a search box 104. By entering one or more search terms into the search box 104, a user can search for related items of content that are available for purchase on the web site. In FIG. 1, the search box 104 is not located over any of the areas 102. Therefore, the search box 104 is used to search for related content of any content type, regardless of whether the content items are electronic items, household items, or clothing items. To indicate that searches will not be performed particular to any content type—or, stated another way, to indicate that searches will be performed over all content items—the element 108 is initially blank. Furthermore, an emphasized border 106 surrounds all the graphical areas 102 to indicate that the scope of searches is not restricted to any particular content type.

The web page 100 includes a drag-and-drop element 108, which may include an icon of a hand. By selecting the element 108, a user can initiate movement of the search box 104, such that the user uses the element 108 to move the search box 108 over the area 102 corresponding to the type of content to which the user wishes to restrict the scope of searches. For example, in a touchscreen environment, a user may select press his or her finger on the touchscreen where the element 108 is displayed, and while still pressing his or her finger on the touchscreen move the finger over the desired area 102. Lifting up his or her finger from the touchscreen causes the search box 104 to be placed, or dropped, at that location.

As another example, in a non-touchscreen environment, a user may move a pointer using a pointing device like a mouse or touchpad over the element 108, and hold down a button on the pointing device. The user then moves the pointer so that the search box 104 moves, or is dragged, over the desired area 102, and releases the button, which causes the search box 104 to be placed, or be dropped, at that location. In both these examples, it is said that the search box 104 is moved from a current location within the web page 100 to a new location within the web page 100, the latter being over one of the areas 102.

In FIG. 2, the drag-and-drop element 108 has been used to move the search box 104 over the area 102B corresponding to household items. Any subsequent searches that are performed via the search box 104 are restricted in scope to just household items, then. To indicate this to the user, the text initially displayed within the search box 104 has changed from being blank to including “HOUSEHOLD.” Similarly, the emphasized border 106 now surrounds just the area 102B, and not the area 102A or 102C.

The example of FIGS. 1 and 2 shows how the same search box 104 can be used to search different content types. As such, multiple search boxes—one for each type of content—are not required. Furthermore, a dropdown box to specify the content type to which the scope of searches should be restricted is unnecessary. In another implementation, no additional GUI element is necessary, in fact. For instance, rather than displaying the drop-and-drop element 108 to permit the search box 104 to be moved within the web page 100, the search box 104 itself may have drag-and-drop capability. In this implementation, no dropdown box or any other GUI element is required to restrict search scope.

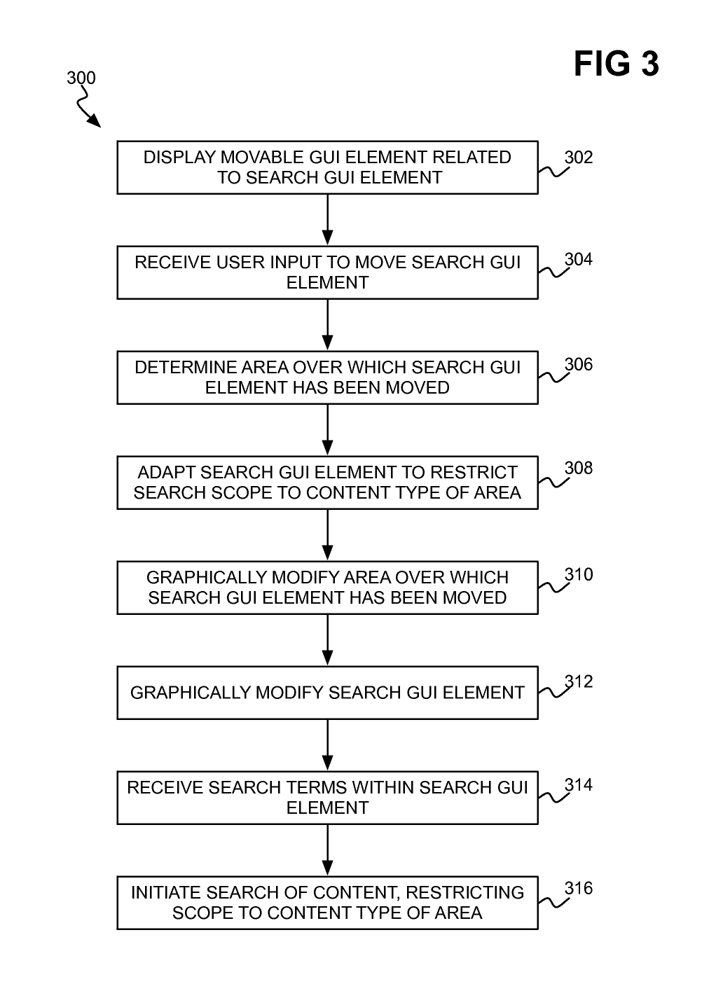

FIG. 3 shows a method 300, according to an embodiment of the disclosure. A computing device performs the method 300. The computing device may be a server computing device, such as a server hosting a web site. The computing device may instead be a client computing device, such as a desktop or laptop computer, a smartphone, a tablet, or another type of computing device, which accesses a web site.

A movable GUI element related to a search GUI element may be displayed within a GUI having a number of areas (302). An example of such a GUI is a web page of a web site, as described above in relation to FIGS. 1 and 2. However, the GUI may not be related to a web page of a web site. For example, the GUI may be the interface by which a database computer program permits a user to conduct searches of content stored in a database.

An example of a search GUI element is a search box, as described above in relation to FIGS. 1 and 2. An example of a movable GUI element is a drag-and-drop element, as has also been described above in relation to FIGS. 1 and 2. However, other types of search GUI elements, and/or other types of movable GUI elements may be employed. Furthermore, no movable GUI element may be displayed.

User input is received to cause the search GUI element to move within the GUI (304). Such user input can be effectuated as has been described above in relation to FIGS. 1 and 2. As also noted, the GUI has a number of areas that correspond to different content types of content that can be accessed or retrieved through the GUI. The content may include a number of content items, each of which is associated with one or more content types by which the content items are organized. The user input causes the search GUI element to move over one of the areas, to select a corresponding content type.

The area over which the search GUI element has been moved is determined (306). In response, the search GUI element is adapted so that the scope of searches performed using the search GUI element is restricted to the content type of the selected area (308). As noted above, this means that subsequent searches do not display search results of content items of any content type, but just relevant content items that match the content type of the selected area.

As an example by which the adaptation of part 308 can be achieved, the selected area over which the search GUI element has been moved within the GUI may be provided by a first software component, and the search GUI element itself may be provided by a second software component. Inter-component communication occurs so that the latter component learns from the former component how to limit searches to just the content type corresponding to the selected area. For example, the second software component may inform the first software component an identifier or string corresponding to this content type. As another example, the second software component may inform the first software component how to structure queries so that searches are restricted to this content type.

To provide visual feedback to the user as to the content type of selected area over which the search GUI element has been moved, the selected area may be graphically modified (310), and/or the search GUI element itself may be modified (312). Such graphical modification can be effectuated as has been described above in relation to FIGS. 1 and 2. Other types of graphical modification can also be achieved to visually indicate to the user the content type to which subsequent searches using the search GUI element will be restricted in scope.

The search GUI element is then used to perform searches of the content, where the searches are restricted in scope to the content type of the selected area of the GUI. Specifically, one or more search terms are received within the search GUI element (314). For example, a user may select the search GUI element, and provide the search terms by entering them in using a keyboard. A search of the content is initiated in relation to these search terms, but specifically just of the content that has the content type of the selected area (316). Search results may then be displayed, and so on.

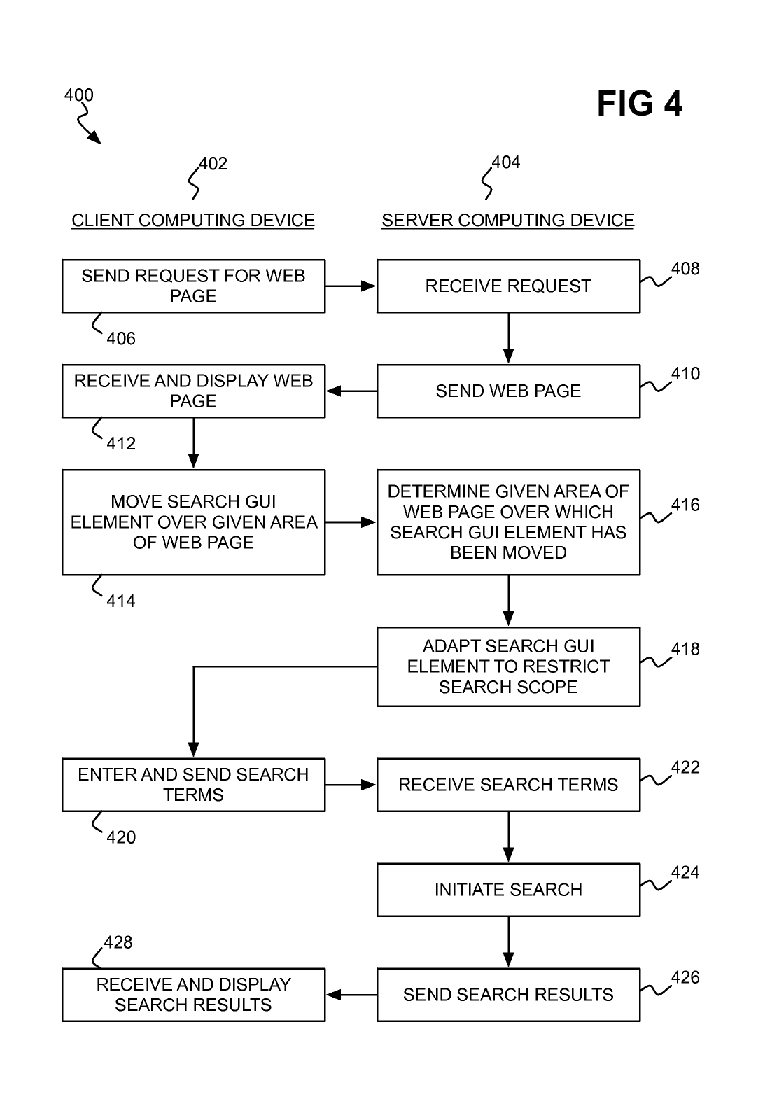

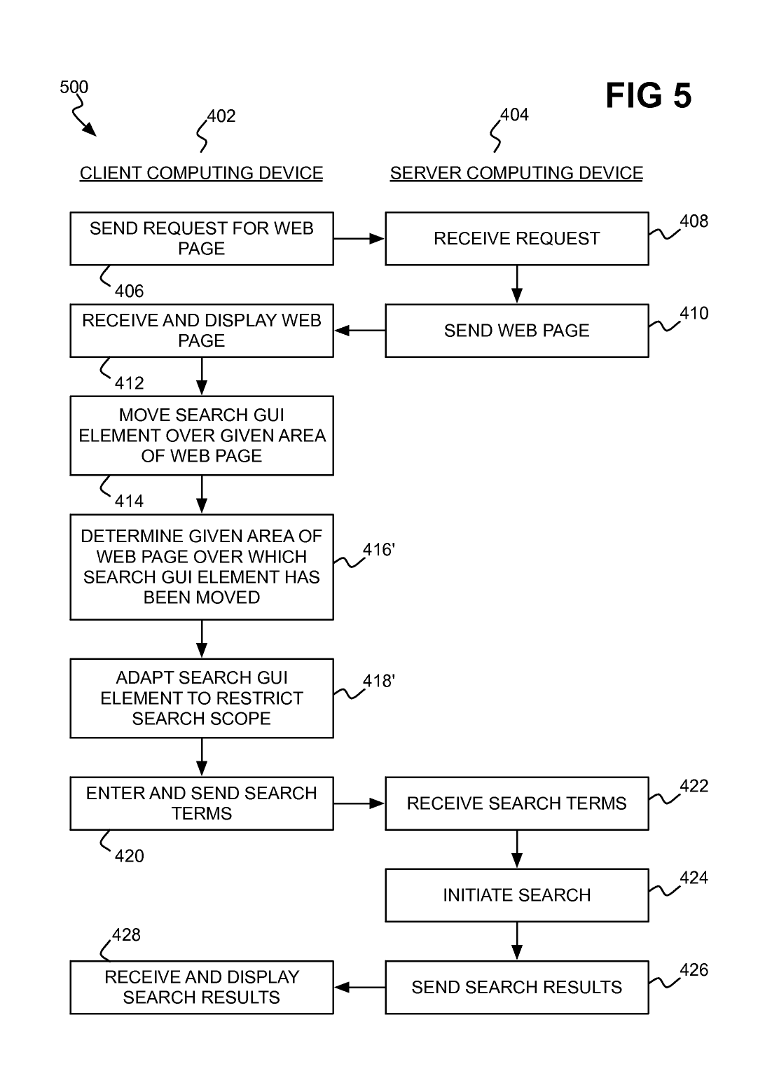

FIGS. 4 and 5 show communication flows 400 and 500, respectively, according to different implementation embodiments of the disclosure. Both FIGS. 4 and 5 are performed in relation to a client computing device 402 and a server computing device 404 that are communicatively connected to one another over a network. In FIG. 4, the search scope restriction functionality that has been described is performed at least primarily at the server computing device 404. By comparison, in FIG. 5, the search scope restriction functionality that has been described is performed at least primarily at the client computing device 402.

Referring first to FIG. 4, the client computing device 402 sends a request for a web page (406), which the server computing device 404 receives (408). The server computing device 404 responsively sends the web page (410), which the client computing device 402 receives and displays (412). It is noted that in actuality, a web page is typically made up of a number of files, such that a number of requests and responses will usually be transferred between the server computing device 404 to the client computing device 402, to realize parts 406, 408, 410, and 412.

At the client computing device 402, a search GUI element of the web page is moved over a given area of the web page corresponding to a desired content type (414). The server computing device 404 in response determines this given area (416), and adapts the search GUI element to restrict the search scope to the desired content type of the given area (418). For instance, the server computing device 404 may configure one or more parameters so that search queries entered using the search GUI element at the client computing device 402 are appropriately restricted in search scope. In this sense, the search GUI element is adapted to restrict the search scope at the server computing device 404, and not at the client computing device 402.

Insofar as visual feedback to the user is provided as to the restriction in search scope, the server computing device 404 may send the client computing device 402 information as to how to update the search GUI element and/or the given area that has been selected, consistent with parts 310 and 312 of the method 300. At some point, then, one or more search terms are entered within the search GUI element at the client computing device 402 and sent (420). The server computing device 404 receives the search terms (422), and initiates a search that is appropriately restricted in search scope (424). The server computing device 404 sends the search results (426), which the client computing device 402 receives and displays (428).

Referring next to FIG. 5, as in FIG. 4, the client computing device 402 sends a web page request (406), which the server computing device 404 receives (408), and in response sends the requested web page to the client computing device 402 (410). The client computing device 402 receives and displays the web page (412), and the search GUI element is moved over a given area of the web page at the client computing device 402 (414), also as in FIG. 4. As such, parts 406, 408, 410, 412, and 414 can be identically performed in both FIGS. 4 and 5.

However, unlike in FIG. 4, in FIG. 5 the client computing device 402 determines the given area of the web page over which the search GUI element has been moved (416′), and adapts the search GUI element to restrict the search scope (418′). For example, the web page that the server computing device 404 sent to the client computing device 402 may include software code that is executed at the client computing device 402 to achieve the functionality of parts 416′ and 418′. Therefore, the search scope restriction is effectively achieved at the client computing device 402 instead of at the server computing device 404.

The remaining parts of FIG. 5 are at least similar to their counterparts in FIG. 4. One or more search terms are entered at the client computing device 402 and sent to the server computing device 404 (420). The sever computing device 404 receives the search terms (422), initiates a search (424), and sends the search results 426 back to the client computing device 402 (426). The client computing device 402 receives and displays the search results in response (428).

As a concrete example of the difference between the adaptation of the search GUI element to restrict the search scope in part 418 of FIG. 4 and the corresponding adaptation in part 418′ of FIG. 5, consider the following. In some implementations of the search GUI element, the search GUI element may simply receive search terms at the client computing device 402 that are then sent to the server computing device 404. In this case, the search GUI element itself is unable to specify the content type to which the scope of the search is to be restricted at the time entered search terms are sent from the client computing device 402 to the server computing device 404. Therefore, the search scope restriction (i.e., the search GUI element adaptation) is performed at the server computing device 404 in part 418 of FIG. 4. That is, one or more parameters are set at the server computing device 404, so that the subsequently received search terms will be part of a search that are appropriately restricted in search scope.

By comparison, in other implementations of the search GUI element, the search GUI element may be able to provide both the search terms and the content type to which a search is to be restricted to the server computing device 404. In this case, in other words, the search GUI element itself is able to specify the content type to which the scope of the search is to be restricted at the time entered search terms are sent from the client computing device 402 to the server computing device 404. Therefore, the search scope restriction (i.e., the search GUI element adaptation) is performed at the client computing device 402 in part 418′ of FIG. 5. When sending the search terms in part 420, for instance, the client computing device 402 may also send the content type to which the scope of the search is to be restricted. The server computing device 404 does not itself have to adapt the search GUI element to restrict the search scope, because the client computing device 402 sends both the search terms and the content type to which the search scope is to be restricted in part 420.

It is noted, however, that although the implementations of FIGS. 4 and 5 that have been described above are in relation to two computing devices, in other implementations, just one computing device—or more than two computing devices—can be employed. For example, in a non-web site context in which the same computing device initiates and/or performs the search and also displays the results of the search to the user, just one computing device may be needed. As another example, in a web site context in which the server computing device 404 is a proxy or otherwise uses another server computing device to perform the search, there will be at least three computing devices to effect the search functionality that has been described.

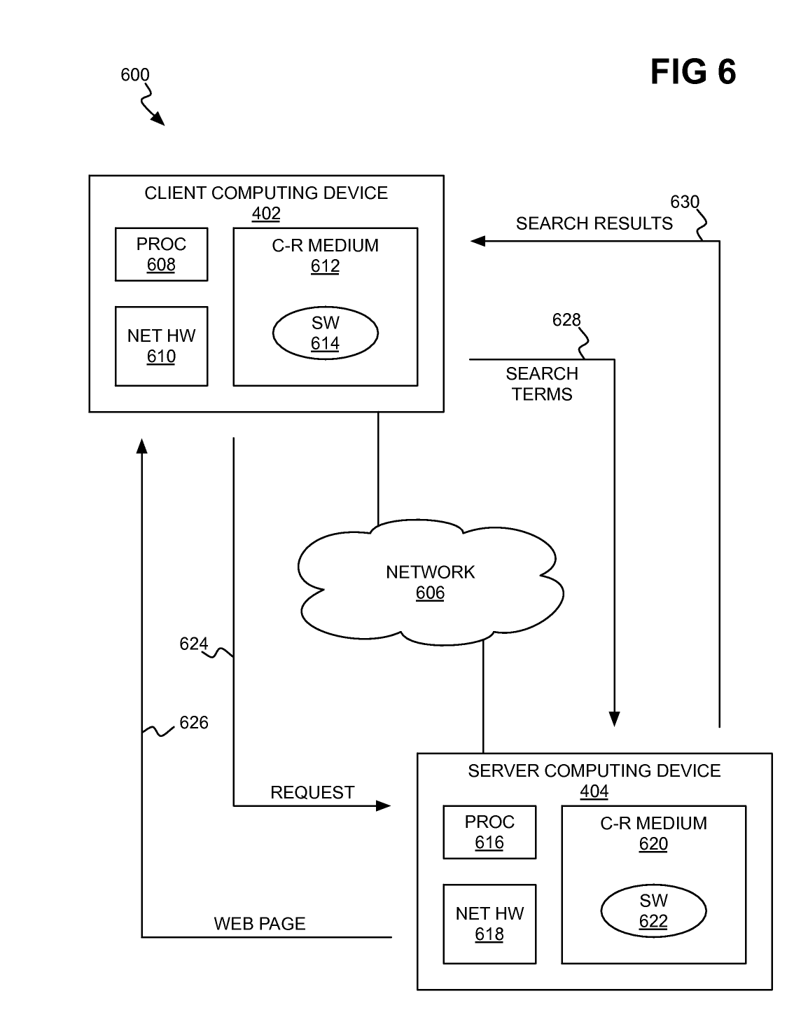

FIG. 6 shows a computing system 600 by which the implementations of FIGS. 4 and 5 can be achieved, according to an embodiment of the disclosure. The system 600 includes the client computing device 402 and the server computing device 404, interconnected via a network 606. The network 606 can include one or more of the Internet, an intranet, an extranet, a wired network, a wireless network, a cellular network, and so on.

The client computing device 402 includes at least a processor 608, network hardware 610, and a computer-readable data storage medium 612 storing software 614. Similarly, the server computing device 404 includes at least a processor 616, network hardware 618, and a computer-readable data storage medium 620 storing software 622. The computing devices 402 and 404 can and typically do include other components, in addition to and/or in lieu of those depicted in FIG. 6.

The networking hardware 610 permits the client computing device 402 to communicate with the server computing device 404 over the network 606. Likewise, the networking hardware 618 permits the server computing device 404 to communicate with the client computing device 402 over the network 606. The processor 608 of the client computing device 402 executes the software 614 from the computer-readable data storage medium 612 to perform the functionality ascribed to the client computing device 402 in relation to FIGS. 4 and 5. Likewise, the processor 616 of the server computing device 404 executes the software 622 from the computer-readable data storage medium 620 to perform the functionality ascribed to the server computing device 404 in relation to FIGS. 4 and 5.

As such, in general terms summarizing the operation of FIGS. 4 and 5 above, the client computing device 402 sends the server computing device 404 a request for a web page (624), and the server computing device 404, which is hosting a web site encompassing the web page, responsively sends the web page back to the client computing device 402 (626). The client computing device 402 and/or the server computing device 404 then ultimately adapt a search GUI element to restrict the search scope to the content type of an area of the web page over which the search GUI element has been moved at the client computing device 404. Thereafter, a search is performed on search terms that the client computing device 402 sends to the server computing device 404 (628), with its scope restricted accordingly, and the server computing device 404 sends results of the search back to the client computing display 402 for display (630).

It is noted that, as can be appreciated by one those of ordinary skill within the art, aspects of the present invention may be embodied as a system, method or computer program product. Accordingly, aspects of the embodiments of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

In general, a computer program product includes a computer-readable medium on which one or more computer programs are stored. Execution of the computer programs from the computer-readable medium by one or more processors of one or more hardware devices causes a method to be performed. For instance, the method that is to be performed may be one or more of the methods that have been described above.

The computer programs themselves include computer program code. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

We claim:

1. A method comprising:
receiving, by a computing device, user input to cause a search graphical user interface (GUI) element to move within a GUI having a plurality of areas, each area corresponding to a content type;
determining, by the computing device, a given area of the plurality of areas over which the search GUI element has been moved; and
adapting, by the computing device, the search GUI element so that a search performable via the search GUI element is restricted in scope to the content type of the given area.

2. The method of claim 1, further comprising:
receiving, by the computing device, one or more search terms provided within the search GUI element; and
initiating in relation to the search terms, by the computing device, a search of content having the content type of the given area.

3. The method of claim 1, further comprising graphically modifying, by the computing device, the given area to provide visual feedback as to the content type of the given area to which the search is restricted in scope.

4. The method of claim 1, further comprising graphically modifying, by the computing device, the search GUI element to provide visual feedback as to the content type of the given area to which the search is restricted in scope.

5. The method of claim 1, further comprising displaying, by the computing device, a movable GUI element related to the search GUI element, the movable GUI element selectable within the GUI to initiate movement of the search GUI element within the GUI.

6. The method of claim 1, wherein the user input comprises user input to perform a drag-and-drop action of the search GUI element to move the search GUI element from a current location within the GUI to a new location within the GUI over the given area.

7. The method of claim 1, wherein the given area is provided by a first software component and the search GUI element is provided by a second software component,
and wherein adapting the search GUI element comprises:
effecting inter-component communication between the first software component and the second software component so that the second software component receives from the first software component information regarding how to perform the search restricted in scope to the content type of the given area.

8. A method comprising:
receiving, by a computing device, user input to cause a search graphical user interface (GUI) element to move within a web page having a plurality of areas, each area corresponding to a content type of content available at a web site encompassing the web page;
determining, by the computing device, a given area of the plurality of areas over which the search GUI element has been moved; and,
adapting, by the computing device, the search GUI element so that a search of the content available at the web site performable by the user via the search GUI element is restricted in scope to the content type of the given area.

9. The method of claim 8, further comprising:
receiving, by the computing device, one or more search terms provided by user input within the search GUI element; and
initiating in relation to the search terms, by the computing device, a search of the content available at the web site having the content type of the given area.

10. The method of claim 8, further comprising graphically modifying, by the computing device, the given area within the web page to provide visual feedback to the user as to the content type of the given area to which the search performable by the user is restricted in scope.

11. The method of claim 8, further comprising graphically modifying, by the computing device, the search GUI element within the web page to provide visual feedback to the user as to the content type of the given area to which the search performable by the user is restricted in scope.

12. The method of claim 8, further comprising displaying, by the computing device, a movable GUI element within the web page that is related to the search GUI element, the movable GUI element selectable within the web page to initiate movement of the search GUI element within the web page.

13. The method of claim 8, wherein the user input comprises user input to perform a drag-and-drop action of the search GUI element to move the search GUI element from a current location within the web page to a new location within the web page over the given area.

14. The method of claim 8, wherein the given area is provided by a first software component and the search GUI element is provided by a second software component,
and wherein adapting the search GUI element comprises:
effecting inter-component communication between the first software component and the second software component so that the second software component receives from the first software component information regarding how to perform the search restricted in scope to the content type of the given area.
